(19) United States
(12) Patent Application Publication
(10) Pub. No.: US 2007/0174315 A1
(43) Pub. Date: Jul. 26, 2007

(54) Compressing state in database replication

(76) Inventors: Avraham Leff, New Hempstead, NY (US); James T. Rayfield, Ridgefield, CT (US)

Correspondence Address: Ido Tuchman, Suite 503, 69-60 108th Street, Forest Hills, NY, 11375, US

(21) Appl. No.: 11/334,599

(22) Filed: Jan. 18, 2006

(51) Int. Cl. G06F 7/00

(52) U.S. Cl. 707/101

(57) ABSTRACT

A method, system and computer program product for compressing state changes to a datum in a primary data storage system. One embodiment of the invention involves receiving a first state-change entry describing at least a first transformation of the datum and an first value of the datum and receiving a second state-change entry describing at least a second transformation of the datum an a second value of the datum. The first and second state-change entries are reduced to a compressed state-change entry including a compressed transformation and a compressed value that are functionally equivalent applying the first transformation and first value, then applying the second transformation and second value, to the datum. The techniques of the invention may be utilized, for example, in redo and undo database replication operations.

### FIELD OF THE INVENTION

The present invention relates generally to computer programs, and more specifically to state compression for database replication.

### BACKGROUND

A distributed client-server environment is a specific type of computing environment. One computing system, referred to as the “server”, is the focal point of such an environment. The server hosts one or more “applications”. Applications are computer program products designed to perform specific functions in accordance with instructions provided to them. One or more computing systems, devices or machines, each referred to as a “client”, interacts with one or more of the applications hosted by the server. For example, a network of cash machines communicating with a central bank computer is typically organized as a client-server environment, with the central back computer acting as the server and the cash machines acting as the clients.

Although a large portion of the processing in a client-server environment is typically performed by the server, clients need not implement a “dumb terminal” interface to the applications on the server. Indeed, a significant amount of processing is frequently performed by the client, greatly reducing the load on the server. Regardless of the degree to which this is the case, any client-server environment requires the client to communicate requests, results and changes to the applications server. To facilitate such communication, the clients are connected with the server via a computer network.

It is not an essential facet of a client-server environment that this network connects each client to the server at all times. Even when the network is consistently available, the network may have such limited bandwidth or such high latency as to make communication between client and server impractical. Additionally, in many useful applications of the client-server concept, there will frequently be instances where no network connection exists. For example, a field technician using a portable computer as a client may be able to connect to the server via the network while at a central office, but may be unable to connect from the field due to no network being available. When the network is not consistently available, clients need to be able to operate independently of the server.

Many computer applications utilize a data store in order to maintain information about system state. A relational database is frequently used to implement such a data store. However, other forms of persistent data storage, such as Extensible Markup Language (XML) files and object serialization techniques in object-oriented programming environments, are also common. It shall be understood that references to a “data store” or “database” throughout this document shall refer to any method or system of storing and retrieving data within any storage medium. Moreover, such a storage medium may be persistent or non-persistent. For example, relational databases can be implemented within non-persistent random access memory or persistent magnetic media memory.

In a client-server environment, an application on the server will usually incorporate a data store as discussed above to maintain information about system state. When this is the case, each client will frequently maintain a local copy or cache of the server's state in its own data store. Examples of clients which maintain a local data store include mobile phones, laptop computers, PDA's, TV set-top boxes, in-vehicle telematics systems and a broad range of embedded devices. Caching of state by the client has numerous advantages. One important advantage is that the client may continue to operate and meet the requirements of applications even if the network connection is unavailable for the reasons discussed above. Another advantage is that even when the network is available, the client can frequently operate on its own data store more efficiently than it can operate on a data store housed on a server.

Synchronization of the client state with the server state is accomplished through a process called “replication.” During replication, while connected to the server, a client replicates the server's data store containing the system state to a data store resident on the client device. The result is that the client's state more closely resembles (or is even identical to) the state on the server. Replication is often associated with a client defining the subset of server state that it wishes to have replicated: this process is termed “subscription.”

Replication is increasingly important as the client is disconnected from the server for increasing amounts of time. Without such replication, the client's state becomes increasingly “stale” as it diverges from the actual state on the server. Also, if the client's state is stale, actions taken on the client (e.g., state updates) are increasingly likely to be invalidated when the client synchronizes its state to the server.

Current approaches realize that transmitting a complete copy of the server data store to each client upon each replication request is very inefficient. The amount of data which differs between the client data store and the server data store is typically very small compared to the total sizes of the data stores. Therefore, it is more efficient for the server to transmit only the state needed to transform the client data store to match the server data store. To perform replication, the server must therefore store, on behalf of all of its clients, sufficient state to transform each client's state, at the time that replication occurs, to the server's current state. In current approaches, the server typically logs the entire set of state changes performed on its data store. Then, it transmits this log (or the subset that applies to a specific client's subscription) to the client. The client applies the log to its data store so as to update its data store with respect to the subscribed state.

For example, consider datum D₁, which had the value d₀ at the time that clientᵢ last replicated from the server. At the time that clientⱼ last replicated from the server, which is later than when clientᵢ last replicated, datum D₁ had the value d₁. Subsequent to both replications, datum D₁ was set to the value d₂ and was then set to the value d₃. Thus, the sequence of state values for D₁ can be written as {d₀,d₁,d₂,d₃}. The server logs this entire sequence. During replication, the server transmits {d₁,d₂,d₃} to clientᵢ and transmits {d₂,d₃} to clientⱼ. In turn, the clients must apply these state changes serially to transform their copies of D₁ that are resident in their data stores so as to synchronize their copies with the server. For example, clientᵢ must first change datum D₁ to the value d₁, then again to the value d₂, then finally to the value d₃.

This approach has two drawbacks. First, the server stores more state than is actually needed for replication on behalf of all of its clients. Second, the server transmits more state to a given client than is needed for the client's replication. The processing of this additional data incurs a penalty in the form of increased bandwidth requirements and increased processing time.

### SUMMARY OF THE INVENTION

The present invention addresses the above-mentioned limitations of the prior art by introducing techniques to compress state changes of maintained data. One exemplary aspect of the present invention is a method for compressing state changes to a datum in a primary data storage system. The method includes receiving a first state-change entry describing at least a first transformation of the datum and a first value of the datum. A second receiving operation receives a second state-change entry describing at least a second transformation of the datum and a second value of the datum. A reducing operation reduces the first and second state-change entries to a compressed state-change entry. The compressed state-change entry includes at least a compressed transformation and a compressed value. Furthermore, the compressed transformation and compressed value are functionally equivalent to applying the first transformation and first value, then applying the second transformation and second value, to the datum.

Another exemplary aspect of the present invention is a system for replicating data. The system includes a primary data store having at least one datum. A logging unit is configured to log state changes of the datum. A replicating unit is configured to compress a plurality of state-change entries into a functionally equivalent state-change entry.

Yet a further exemplary aspect of the invention is a computer program product embodied in a tangible media. The computer program product includes computer readable program codes configured to cause the program to receive a first state-change entry describing at least a first transformation of the datum and an first value of the datum, receive a second state-change entry describing at least a second transformation of the datum an a second value of the datum, and reduce the first and second state-change entries to a compressed state-change entry. The compressed state-change entry includes at least a compressed transformation and a compressed value. Furthermore, the compressed transformation and compressed value are functionally equivalent to applying the first transformation and first value, then applying the second transformation and second value, to the datum.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary client-server environment embodying the present invention.

FIG. 2 shows one configuration of a server implementing an embodiment of the present invention.

FIG. 3 shows an exemplary structure of a state-change entry on a server contemplated by the present invention.

FIG. 4 shows an exemplary flowchart for compressing state changes to a datum in a data storage system.

FIG. 5 shows a flowchart of the specific steps followed by the server in one embodiment of the present invention to dynamically compress state change entries within a single transaction on the server on behalf of all clients.

FIG. 6 shows a flowchart of the steps followed by the server in one embodiment of the present invention to compress a sequence of state change entries within a well-defined range of activity.

FIG. 7 shows a client implementing one configuration of the present invention.

FIG. 8 shows an exemplary structure of a state-change entry on a client.

FIG. 9 shows a flowchart of the specific steps followed by the client in one embodiment of the present invention to dynamically and efficiently compress state change entries within a single synchronization session on a single client.

FIG. 10 shows a flowchart of one embodiment of system operations performed by a client to replicate the state from the server that resulted from a series of transactions that executed on the server.

FIG. 11 shows an exemplary flowchart for system operations performed by the undo middleware through which a client performs an “undo” operation.

FIG. 12 shows an exemplary flowchart for system operations performed by the redo middleware through which a client performs a “redo” operation.

### DETAILED DESCRIPTION OF THE INVENTION

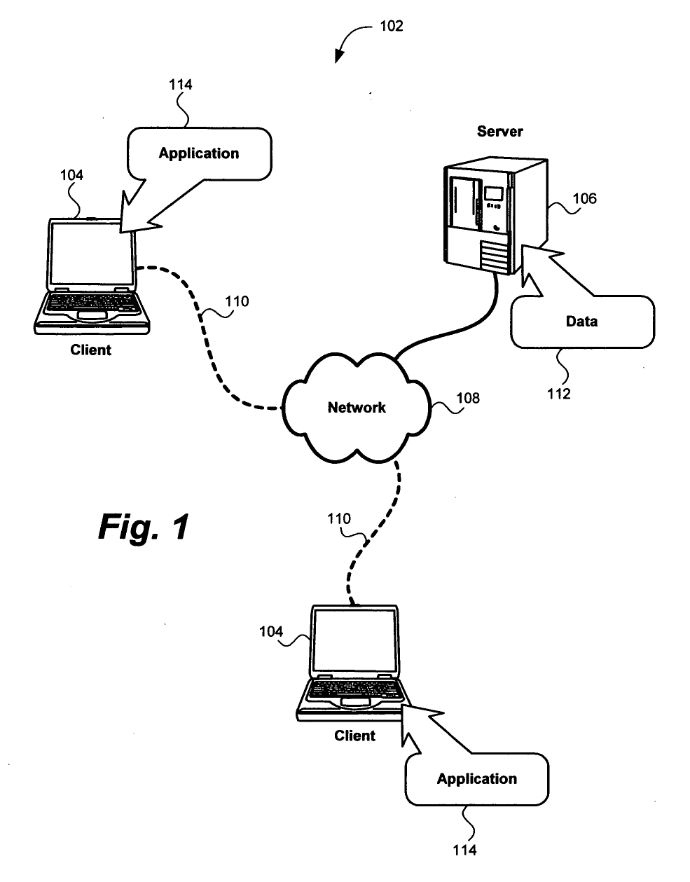

The following description details how the present invention is employed to compress state information in database replication. Throughout the description of the invention reference is made to FIGS. 1-12. When referring to the figures, like structures and elements shown throughout are indicated with like reference numerals.

FIG. 1 shows an exemplary client-server environment 102 embodying the present invention. It is initially noted that the environment 102 is presented for illustration purposes only, and is representative of countless configurations in which the invention may be implemented. Thus, the present invention should not be construed as limited to the environment configurations shown and discussed herein.

The environment 102 includes of one or more clients 104 and a server 106. The clients 104 can communicate with the server 106 via a computer network 108. Communication links 110 couple the clients 104 with the server 106. Furthermore, the Communication links 110 may be only intermittently available or may provide limited bandwidth (represented by dashed lines). For example, a field technician using a portable computer as a client 104 may be able to connect to the server 106 via the network 108 while at a central office, but may be unable to connect from the field due to no network being available.

The computer network 108 may include a combination of wired and wireless connections. Wireless communications within the network 108 may utilize, for example, audio, radio and/or optical carrier frequencies. The computer network 108 may be a Local Area Network (LAN), a Wide Area Network (WAN), a piconet, or a combination thereof. It is contemplated that the computer network 108 may be configured as a public network, such as the Internet, and/or a private network, such as an Intranet or other proprietary communication system. Various topologies and protocols known to those skilled in the art may be exploited by the network 108, such as WiFi, Bluetooth(R), TCP/IP, UDP, GSM, and CDMA. Furthermore, the computer network 108 may include various networking devices known in the art, such as routers, switches, bridges, repeaters, etc.

It is contemplated that the clients 104 may be any electrical device capable of executing the application 114. Such devices may include a general-purpose computer, such as a laptop computer, or more specialized devices, such as a cellular phone, personal digital assistant (PDA), or a television set box. Similarly, the server 106 may be a general-purpose device or a specialized server designed for specific functionality. Moreover, it is contemplated that the server 106 may represent a plurality of servers collectively configured as a server farm to distribute processing load.

The server 106 is responsible for maintaining the primary or master copy of data 112 used by applications 114 running on the clients 104. Although network access to the server 106 may at times be unavailable, the applications 114 at the clients 104 may continue operating by utilizing a local copy of some or all the data 112 at the server 106. Once network access is reestablished, data at the client 104 is synchronized with data 112 at the server 106.

Synchronization of the client state with the server state is accomplished through a process called replication. During replication, a client 104 replicates the server's data store 112 containing the system state to a data store resident on the client device 104. The result is that the client's state more closely resembles (or is even identical to) the state on the server 106.

Replication is typically performed with respect to a well-defined range of activity on the server. For example, since the state change entries have sequence numbers (or timestamps), the activity range can be specified in terms of a range of sequence numbers. Alternatively, the activity range can be specified as a window of time. For example, replication may include replicating all activity that occurred on the server in the last twenty-four hours.

As described in detail below, one embodiment of the present invention provides a method for compressing a state-change log for a specified range of server activity. Using the present invention, the state change log is compressed before it is transmitted from the server 106 to the client 104. Compressing the state change log beneficially reduces the bandwidth required to send the log. It also reduces the memory and processing time required to store and process the log.

As described in detail below, it is further contemplated that the state compression technique of the present invention may be applied to the client's activity log as well. Before replication is performed, the client 104 may be required to “undo” any changes to its local data, thereby returning the client 104 to the same state as it was at the close of the last replication. Thus, any changes made on the server 106 since the close of the last replication can be reapplied to this state to obtain the current state of the server data store. The state compression techniques of the present invention, as applied to the client 104, beneficially minimizes storage space required to store the state change logs and the time required to apply the state change log to revert to the state at the close of the last replication.

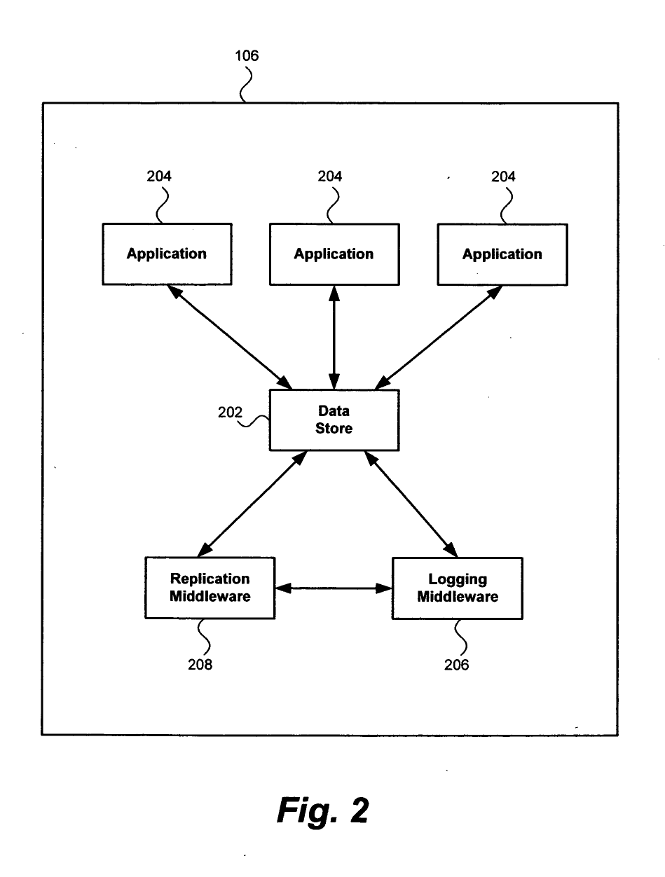

FIG. 2 shows one configuration of a server 106 implementing an embodiment of the present invention. The server 106 contains a data store 202 which maintains the primary version of the state used by executing applications 204. The data store 202 may be a persistent relational database, such as DB2(R). DB2 is a registered trademark of International Business Machines Corporation, located in Armonk, N.Y., USA. It is emphasized, however, that the data store 202 may be any of a wide variety of data store types known to those skilled in the art, such as Extensible Markup Language (XML) files, objects, and other data structures. As applications 204 execute on the server 106, or as clients synchronize their activity with the server 106, the data store 202 is modified, and the corresponding state change entries are logged by the logging middleware 206. The logging middleware 206 dynamically compresses state change entries within a single transaction on behalf of all clients. Replication middleware 208 further compresses the state change log when replicating a specified set of activity to a specific client.

For both transactional and non-transactional systems, when replicating to a specific client, the server 106 can compress the state change log across an entire activity range of state change entries for which the client wishes the server's activity to be replicated. As a result of this compression, the state change log contains at most one state change entry per datum across the activity range. Only the compressed form of the state change log is transmitted to the client, resulting in a significant savings of bandwidth and processing time.

It is further contemplated that the server 106 can compress its internal state change logs based on its knowledge of the clients which have subscribed to it. Clients will generally replicate all state changes on the server from the close of their most recent replication up to approximately the present moment. In systems which are guaranteed to exhibit this behavior, the server 106 can compress all activity over any activity range which does not include the close of any client's replication. For example, if the close of the last replication of clientᵢ occurred at timeᵢ and no client had the close of its last replication between timeᵢ and timeⱼ, all activity between timeᵢ and timeⱼ can be compressed. This is possible because no client will request intermediate data between timeᵢ and timeⱼ. Thus, in this case, only the compressed version of the state change log for this activity range is stored. Performing such compression has two advantages. First, the space required on the server to store the state change logs is decreased. Second, the time required to compress the state change log required for the replication of a specific requirement is diminished, because part of the work has already been completed in a manner which applies to all clients. It is emphasized that this technique is an optional feature of the present invention.

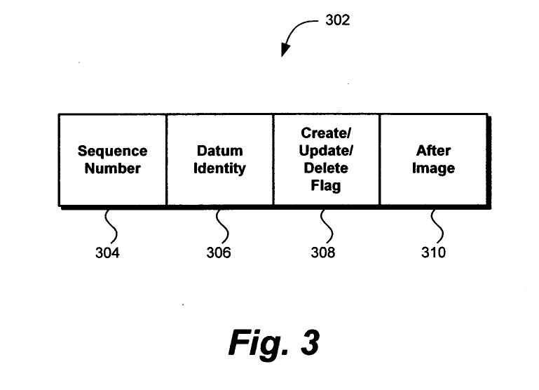

FIG. 3 shows an exemplary structure of a state-change entry 302 on a server. The state-change entry 302 includes the following information: a sequence number field 304 or timestamp specifying where in the sequence of state changes the logged state change occurred; an identifier field 306 that uniquely identifies the datum whose state change is being logged; a transformation field 308 indicating whether the state change represents the creation of the datum, an update of the datum, or the deletion of the datum; and an after-image field 310 identifying the state of the datum itself after the operation was performed (except for Delete operations, for which the after-image is null).

State-change entries 302 may be organized in a state-change log file. Thus, the log file is a record over time of changes made to at least one datum in a data structure. It is contemplated that the state-change entries 302 may be embodied in various computer-readable media, including a propagating signal passing through a computer network.

One embodiment of the present invention utilizes the transactional nature of a system to further compress the state-change log before server-to-client replication occurs. For example, the state-change entries for each transaction are compressed using an embodiment of the present invention (described below) before the log is written. As a result, at most one state-change entry per datum per transaction will be written to the local storage device. This is possible because in transactional database systems, transactions are “atomic”, meaning that they either occur completely (all operations in the transaction execute successfully) or do not occur at all (none of the operations in the transaction execute). For more information about transactional systems, see J. Gray et al., Transaction Processing: Concepts and Techniques, Morgan Kaufmann, 1993, incorporated in its entirety herein by reference.

It is noted that an embodiment of the present invention does not require data stores to be transactional. In non-transactional systems, for example, the server writes a state-change log to a local storage device and the state-change entries 302 for each individual operation are written to the state-change log as they occur.

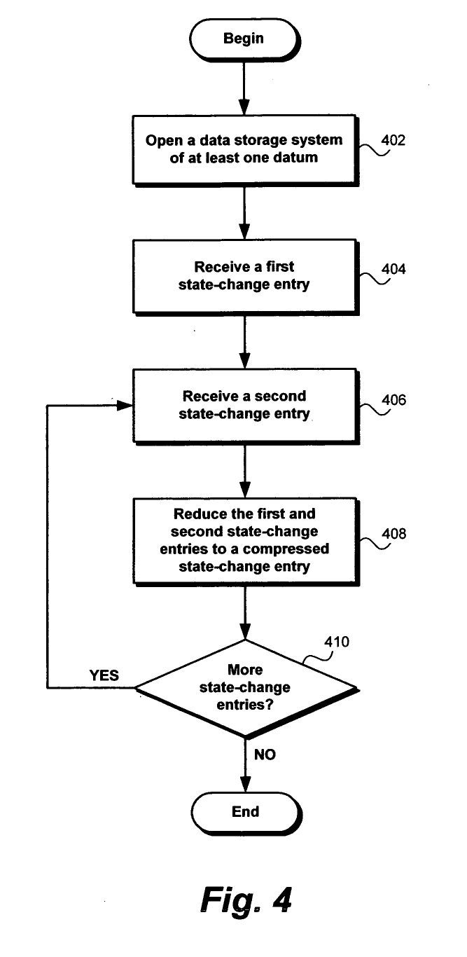

Turning now to FIG. 4, an exemplary flowchart for compressing state changes to a datum in a data storage system is shown. It should be remarked that the logical operations shown may be implemented (1) as a sequence of computer executed steps running on a computing system and/or (2) as interconnected machine modules within the computing system. Furthermore, the operations may be performed on a virtual machine abstracted in a computer platform, such as the Java Virtual Machine (JVM) executing over a native operating system. The implementation is a matter of choice dependent on the performance requirements of the system implementing the invention. Accordingly, the logical operations making up the embodiments of the present invention described herein are referred to alternatively as operations, steps, or modules.

Operational flow begins with opening operation 402. During this operation, the data storage system containing information about at least one datum of interest is accessed. As mentioned above, the data storage system may be a relational database or some other data framework. Furthermore, the data storage system may be transactional or non-transactional, depending on system requirements. Once the data storage system is accessed, control passes to receiving operation 404.

At receiving operation 404, a first state-change entry is accessed. As discussed above, the state-change entry describes at least a transformation of the datum and a value of the datum. In one embodiment of the invention, transformations of an individual datum in the data store can be defined as being create, update or delete operations. A create operation is any operation which creates a datum which had not heretofore existed and assigns it a value. An update operation is any operation which assigns a value to a datum which already exists. A delete operation is any operation which causes a datum to no longer exist. For the purposes of these operations, a special value indicating the lack of a value, such as the NULL value in relational databases and object-oriented languages and databases, shall be considered a value. After receiving operation 404 is completed, control passes to receiving operation 406.

At receiving operation 406, a second state-change entry is accessed. Again, the state-change entry describes at least a transformation of the datum and a value of the datum. It is contemplated that the state-change entries are stored in a state-change log file. Thus, receiving operations 404 and 406 involve basic file access operations known to those skilled in the art. After receiving operation 406 is completed, control passes to reducing operation 408.

At reducing operation 408, the first and second state-change entries are reduced to a compressed state-change entry. The compressed state-change entry includes at least a compressed transformation and a compressed value, with the compressed transformation and compressed value being functionally equivalent to combining the first transformation and second transformation of the datum at the first value and second value of the datum. It is contemplated that the compressed transformation includes an indication as to whether the state change represents a creation of the datum, a deletion of the datum, or an update of the datum. After reducing operation 408 is completed, control passes to determining operation 410.

At determining operation 410, the state-change log is examined to determine if there are remaining state-change entries that need to be compressed. Thus, this operation allows state-change entry compression to be iteratively performed over a specified range of activity. In one embodiment of the present invention, it is assumed that the system is transactional, and that activity ranges are specified as transaction ranges. A transaction range is a series of transactions txₘ . . . txₙ; all transactions occurring after txₘ and before txₙ (and inclusive of txₘ and txₙ themselves) are included within the transaction range. The server thus replicates all activity that occurred within a specified series of transactions. In another embodiment of the present invention, the activity range is specified as a time range. A time range is all activity occurring on or after time tₘ and on or before time tₙ. Note that this activity may or may not be transactional. The server thus replicates all activity that occurred within the specified time range.

If additional state-change entries are present that need compressing, control returns to receiving operation 406 where this entry is compressed with the result of the previous iteration. Once all the state-change entries have been processed and determining operation 410 finds no more entries for compression, the process ends. It is noted that embodiments of the invention may be applied for database state that is accessed through a component model with well-defined lifecycle create/update/delete operations, such as Enterprise JavaBeans.

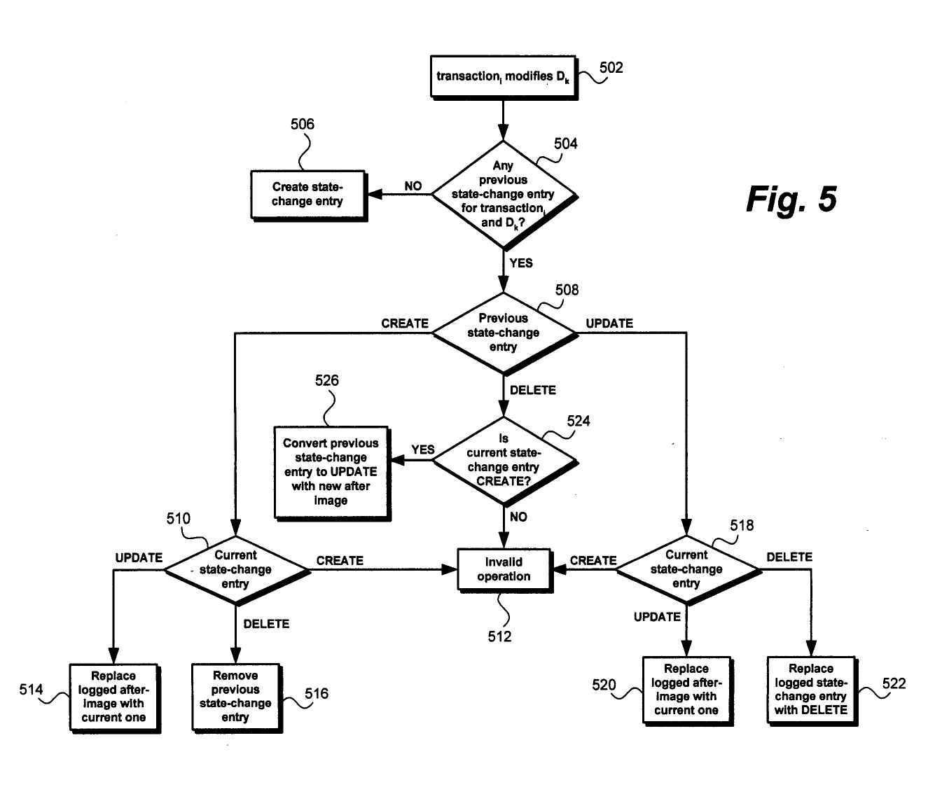

FIG. 5 shows a flowchart of the specific steps followed by the server in one embodiment of the present invention to dynamically compress state change entries within a single transaction on the server on behalf of all clients. The process begins with transforming operation 502, wherein transactionᵢ executing on the server modifies the database by creating, updating, or deleting datum Dₖ. At determining operation 504, the logging middleware determines whether any state-change entry has previously been logged for transactionᵢ and datum Dₖ. If no such state change entry has previously been logged, the logging middleware creates in operation 506 a state-change entry, as described above, corresponding to the action modifying the database. The state-change entry is logged as a create, update or delete operation according to the action actually performed upon datum Dₖ. The after-image is logged as the actual value to which datum Dₖ is set, except in the case of a delete operation, in which the after-image is logged as null. If, at determining operation 504, the logging middleware determines that a state-change entry has previously been logged for transactionᵢ and datum Dₖ, control passes to determining operation 508.

At determining operation 508, the logging middleware determines whether the previous entry corresponds to a create, update, or delete operation. If the logged entry corresponds to a create operation, control passes to determining operation 510, where the server determines whether the current operation is a create, update or a delete operation. If the current operation is a create operation, this indicates the datum was created twice, and is considered an error. Thus, control passes to invalidating operation 512, where error-handling operations are performed.

If, at determining operation 510, the current operation is determined to be an update operation, control passes to replacing operation 514. At replacing operation 514, the server replaces the logged after-image with an after-image corresponding to the actual value to which datum Dₖ was set. If, at determining operation 510, the current operation is determined to be a delete operation, control passes to removing operation 516. At this operation, the server removes the state-change entry for the logged create operation and does not log the current operation.

If, at determining operation 508, the logged entry corresponds to an update operation, control passes to determining operation 518. At determining operation 518 the current state-change entry is examined. If the current state-change entry is determined to be a create operation, an error condition exists since an update to the datum cannot be followed by an operation to create the datum. Thus, control passes to invalidating operation 512 for this condition.

If, at determining operation 518, the current operation is determined to be an update operation, control passes to replacing operation 520. At replacing operation 520, the server replaces the logged after-image with an after-image corresponding to the actual value to which datum Dₖ was set. If, at determining operation 518, the current operation is determined to be a delete operation, control passes to replacing operation 522. At this operation, the server replaces the logged state change entry with one that corresponds to a delete operation.

Returning to determining operation 508, if the logged entry corresponds to a delete operation, control passes to determining operation 524. At determining operation 524, the server confirms that the current operation is a create operation. If the current operation is not a create operation, it is an invalid operation and control passes to invalidating operation 512. If the operation is in fact a create operation, control passes to converting operation 526. During this operation, the server converts the logged state change entry to correspond to an update operation. The converting operation 526 also replaces the logged after-image with an after-image corresponding to the actual value to which datum Dₖ was set.

It is emphasized that the operations shown in FIG. 5 process all valid combinations of database operations that involve the creation, update or deletion of a given Dₖ in a given transactionᵢ. A transaction such as transactionᵢ may include one or more separate operations. Each operation causes zero or more data Dₖ to be created, updated or deleted. For each datum Dₖ modified in each operation and for each operation within transactionᵢ, the logging middleware performs the steps described above. Even though the method shown in the flowchart is generally performed more than once per transaction, each execution operates on the same state-change log. Thus, the end result of this compression when applied to state-change operations executing within a single transaction is a state-change log in which no more than one state change entry is recorded per datum Dₖ.

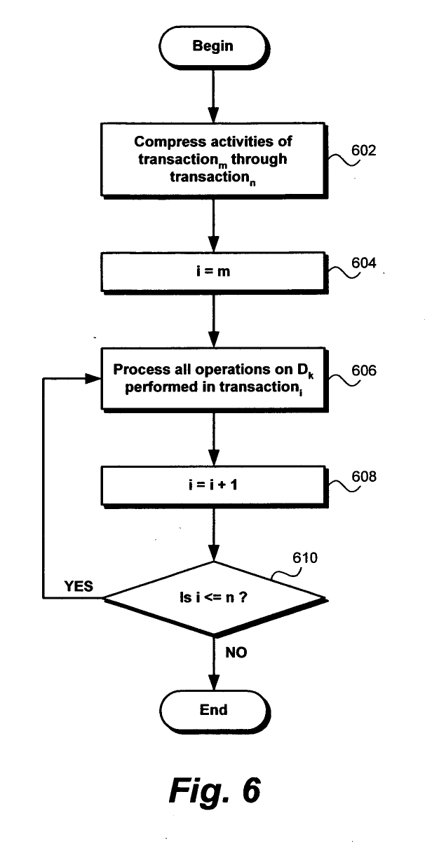

Turning now to FIG. 6, a flowchart is presented showing the steps followed by the server in one embodiment of the present invention to compress a sequence of state change entries within a well-defined range of activity. While FIG. 6 defines the range of activity as a sequence of transactions, it is contemplated that this procedure can be applied to any well-defined sequence of activity on the server.

In step 602, the necessary initialization is performed to prepare to compress the existing state change logs for all activity occurring between transactionₘ and transactionₙ, inclusive. The initialization process may include the creation of a new state-change log to contain the compressed form of all state-change logs for the entire activity range. As of this step, the new, combined state change log does not yet contain any state change entries.

In step 604, a loop is commenced to iterate over all transactions transactionᵢ for m<=i<=n. A variable i, which serves as a counter variable for this loop, is assigned the value m.

In step 606, the state-change log for transactionᵢ is compressed, as described above for FIG. 5. It is known that the state change log for transactionᵢ contains at most one state change entry per datum, as this is a property of the compression process. Thus, the operations in the flowchart of FIG. 5 are performed upon each state-change entry in the state-change log for transactionᵢ. The state-change entries generated are written to the combined state-change log created in initialization step 602. In one embodiment of the invention, the original state change log for transactionᵢ is not modified, as it may need to be compressed again in the future for another client.

The counter variable i is incremented at step 608 and, in step 610, the value of the counter variable i is compared with the value of n to determine whether the process is complete. If i is less than or equal to the value n, execution returns to step 606 where the next transaction is compressed. When complete, the process terminates.

The end result of FIG. 6 is that the combined state-change log created by this procedure contains a compressed form of all activity occurring between transactionₘ and transactionₙ, inclusive. As with the compression within a single transaction, the combined state-change log contains no more than one state-change entry per datum Dₖ.

By following the procedure described above and shown in FIGS. 5 and 6, the present invention may be utilized to compress the state which must be stored by the server for an arbitrary range of activity in order to replicate to all clients and to compress the state that the server must transmit to a specific client for a specific range of activity. However, to apply the state change log to the client data store, the client data store typically must be in the same state as it was at the close of the last replication. At the close of the last replication, the client data store and the server data store were of the same state. Thus, any changes made on the server since the close of the last replication can be reapplied to this state to obtain the current state of the server data store.

An embodiment of the present invention utilizes a compression technique similar to the one used on the server to compress the state change log for a synchronization session. Performing such compression has two advantages. First, the space required on the client to store the state change logs is decreased. Second, the time required to apply the state change log to revert to the state at the close of the last replication is diminished.

In a further embodiment of the present invention, the state-change log on the server and the state-change log on the client are used synergistically to efficiently modify the client state to match the server state. First, in an “undo” operation, the client applies its state change log for the synchronization session to return to the state at the close of the last replication. Second, in a “redo” operation, the client applies the server's state change log to advance from this state to the current or near-current server state.

It is noted that since any state changes made locally on the client are reversed by this process, the client may need to communicate such changes to the server before commencing the replication process. It is contemplated that the server may apply the client's state changes to its own state before replication, causing them to be incorporated on the server. However, any such synchronization issues are outside the scope of the present invention.

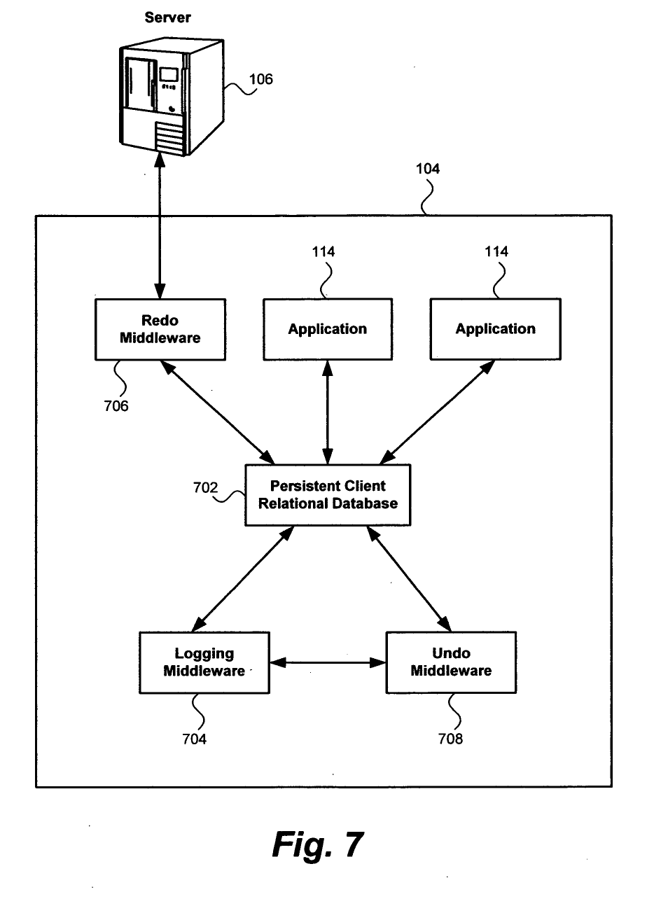

FIG. 7 shows a client 104 implementing one configuration of the present invention. As mentioned above, the connection between the client 104 and the server 106 may be only intermittently available. The client 104 contains one or more applications 114 that can execute while disconnected from the server 106. Each application 114 uses a data store 702 to access and modify state pertaining to that application. The data store 702 may be a persistent client relational database, such as DB2(R). As the applications 114 execute, logging middleware 704 logs state change entries from those applications in a manner that is transparent to the applications 114. Whenever a connection exists-between the client 104 and the server 106, the client 104 has the opportunity to refresh its data store by interacting with the server 106 in a replication process that replicates the server's current state to the client 104. Replication resolves any staleness occurring due to a period of time during which the client 104 was disconnected from the server 106. The replication process is discussed in detail below.

The redo middleware 706 is configured to receive compressed state information from the server 106, bringing the client 104 and server 106 to the same updated state. As mentioned above, however, before doing so, the client must typically “undo” any changes to data store 702 since the last replication. The undo middleware 708 is assigned this task. Thus, an embodiment of the present invention logs changes on the client 104 in a “synchronization session”. A synchronization session groups all activity between two consecutive synchronization activities with the server. It includes one or more activity sequences or sequences of transactions executed on the client 104.

In an alternative embodiment of the present invention, it is assumed that the client data store is used in a read only fashion. Thus, there is no need to reverse any changes. As a result, only the “redo” operation described above is performed to modify the client state to match the server state.

In another embodiment of the present invention, the “undo” operation described above is used independently of the “redo” operation and of replication in general. The “undo” operation thus provides a method to revert a single database from its current state to its state at a specific point in time which is efficient in terms of processing time and disk space required.

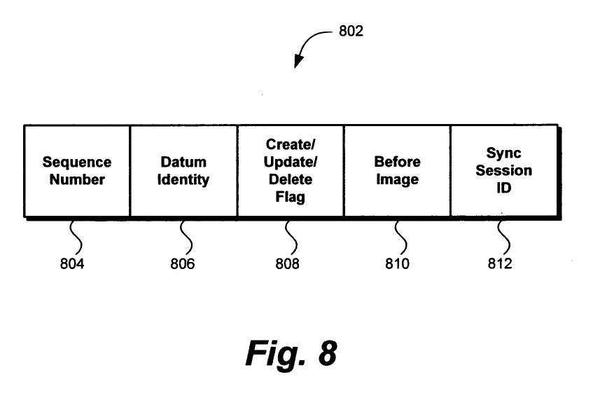

FIG. 8 shows an exemplary structure of a state-change entry 802 on a client. The state-change entry 802 contains the following information: an identifier 812 that uniquely identifies the synchronization session during which this state change occurred; a sequence number 804 or timestamp specifying where in the sequence this state change occurred; an identifier 806 that uniquely identifies the datum whose state change is being logged; a state identifier 810 identifying the state of the datum itself before the operation was performed (hence the term “before-image”), except for Create operations, for which the before-image is null; and a transformation 808 as to whether the state change represents the creation of the datum, an update of the datum, or the deletion of the datum.

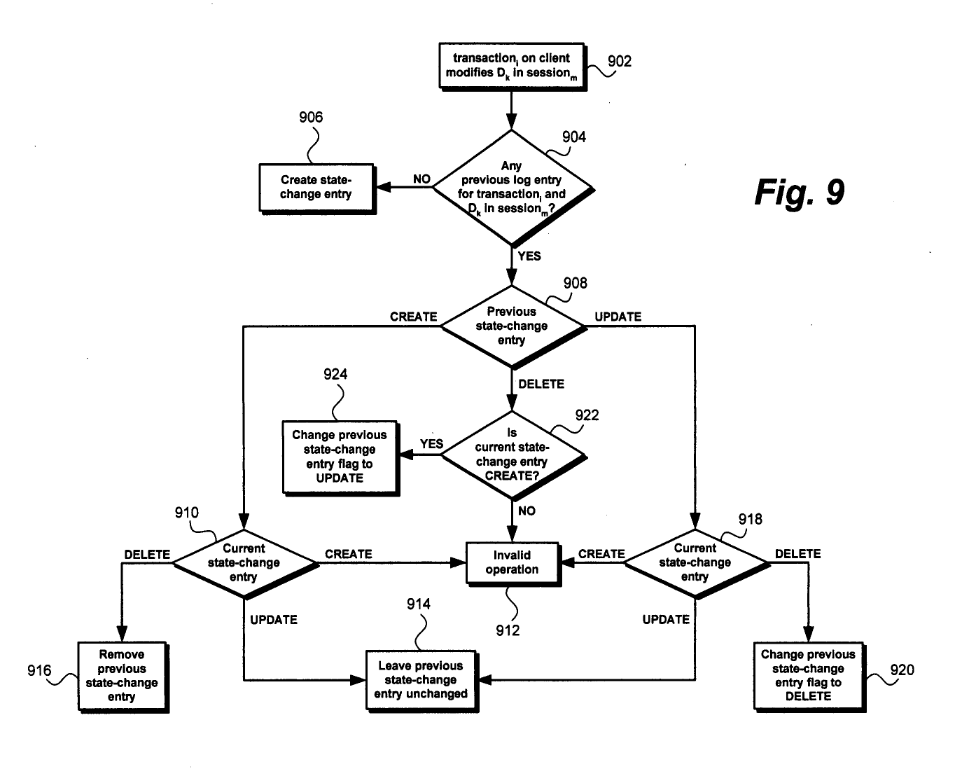

FIG. 9 shows a flowchart of the specific steps followed by the client in one embodiment of the present invention to dynamically and efficiently compress state change entries within a single synchronization session on a single client. The client maintains a state change log so as to be able to perform an “undo” operation to revert to the state obtaining as of the close of the last replication. The reasons why the “undo” operation is desirable and necessary are discussed above.

In step 902, transactionᵢ executing within sessionsₘ on the client modifies the database by either creating, updating, or deleting datum Dₖ. In step 904, the client's logging middleware determines whether any state-change entry has previously been logged during sessionₘ for datum Dₖ. It is emphasized that client-side compression is performed across all transactions executing within a given synchronization session. Therefore, the logging middleware does not need to consider the identity of transactionᵢ. If no such state change entry has previously been logged, the logging middleware creates, in step 906, a state-change entry of the form specified in FIG. 8 that corresponds to the action modifying the database. The state-change entry is logged as corresponding to a create operation, an update operation or a delete operation according to the action actually performed upon datum Dₖ. The before-image is logged as the actual value of datum Dₖ immediately before it was modified, except in the case of a create operation, in which the before-image is logged as null.

If a state change entry has previously been logged, the client, in step 908, determines whether the previous entry corresponds to a create operation, an update operation or a delete operation. If the logged entry corresponds to a create operation, the client determines, in step 910, whether the current operation is a create operation, an update operation, or a delete operation. If the current operation is a create operation, process flow proceeds to step 912 where error handling procedures manage this invalid operation. If the current operation is an update operation, in step 914, the client does not modify the logged update operation and does not log the current operation. This is desirable because the “undo” operation acts upon the first state change entry. If the current operation is a delete operation, in step 916, the client removes the state change entry for the logged create operation and does not log the current operation.

Turning back to step 908, if the logged entry corresponds to an update operation, the client determines in step 918 whether the current operation is an update operation or a delete operation (in this context, a create operation is an invalid operation and control passes to step 912). If the current operation is an update operation, in step 914, the client does not modify the logged update operation and does not log the current operation. This is desirable because the “undo” operation acts upon the first state change entry. This behavior is similar to the case where a create operation is followed by an update operation. If the current operation is a delete operation, in step 920, the client transforms the logged state change entry to one that corresponds to a delete operation. However, the client does not otherwise modify the logged operation and in particular does not modify the before-image. This ensures that the “undo” operation will recreate the datum and revert its state to that obtaining before the update operation.

Turning back again to step 908, if the logged entry corresponds to a delete operation, the client confirms in step 922 that the current operation is a create operation. If so, in step 924, the client converts the logged state change entry to correspond to an update operation. This ensures that the “undo” operation will not attempt to create a datum which already exists. However, the client does not otherwise modify the logged operation and in particular does not modify the before-image. Maintaining the previous value of the before-image ensures that the “undo” operation will restore the datum's state to that obtained at the time of the delete operation. If the current operation is not a create operation, it is an invalid operation and control passes to step 912.

Combinations listed above as an invalid operation 912 are semantically invalid. For example, a logged create operation followed by another create operation is semantically invalid by definition because a create operation can only create a datum which does not already exist. In such cases, step 912 raises an error condition. Thus, FIG. 9 exhaustively processes all valid combinations of database operations that involve the creation, update or deletion of a given Dₖ in a given transactionᵢ.

A synchronization session such as sessionₘ includes one or more separate transactions. Each transaction includes one or more separate operations. Each operation causes zero or more data Dₖ to be created, updated or deleted. For each datum Dₖ modified in each operation, for each operation within transactionᵢ, and for each transactionᵢ within sessionₘ, the logging middleware performs the steps described above. Although the depicted flowchart is generally performed more than once per session, each execution operates on the same state change log. Thus, the end result of this compression when applied to state change entries executing within a single synchronization session is a state change log in which no more than one state change entry is recorded per datum Dₖ for the entire sessionₘ. Thus, the outcome is that the state change log contains exactly enough information to allow the client to perform the “undo” operation.

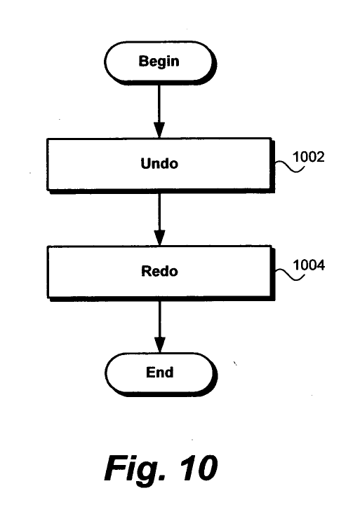

In FIG. 10, a flowchart illustrates one embodiment of system operations performed by a client to replicate the state from the server that resulted from a series of transactions that executed on the server and that start with transactionₛ. In step 1002, the client performs an “undo” operation to restore the local database state to that obtained at the close of the last replication. The last replication brought the client up-to-date with respect to all server transactions until (but not including) transactionₛ. The “undo” operation uses the compressed state change log from the client created as described in FIG. 9. The details of step 1002 are discussed below.

In step 1004, the client performs a “redo” operation to update the local database state and incorporate the state changes that occurred on the server during the sequence of activity that begins with transactionₛ and ends with some transactionⱼ. transactionⱼ is arbitrarily selected by the server but cannot have occurred prior to transactionₛ. The “redo” operation uses the compressed state-change log from the server created as described in FIG. 6. The details of step 1004 are discussed below.

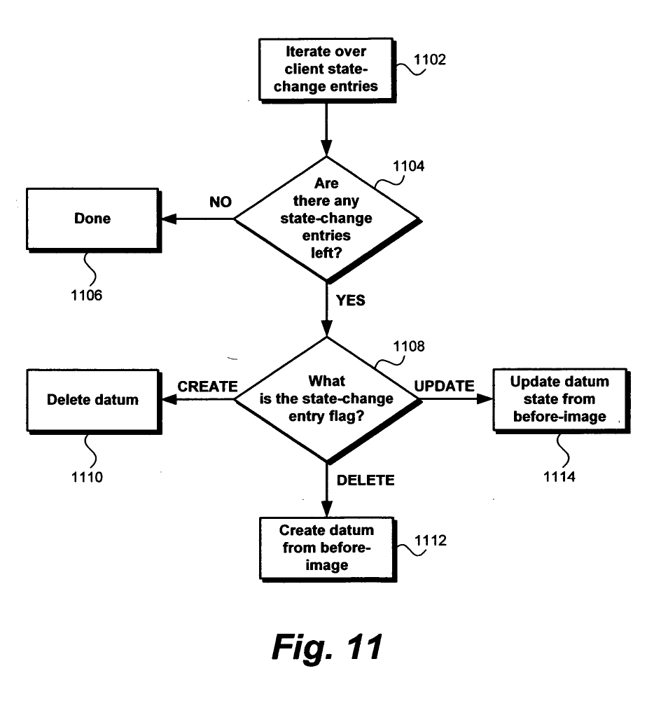

Turning now to FIG. 11, a flowchart shows exemplary system operations performed by the undo middleware through which a client performs an “undo” operation. The “undo” operation restores the client's local database to its state at the close of the last replication with the server. For discussion purposes, assume that at the conclusion of the previous replication, sessionₘ had been initiated. Therefore, all modifications made to the client database since the previous replication have been logged in state change entries with a synchronization session of sessionₘ. To undo all modifications made to the client database since the previous replication, it therefore suffices to undo all state change entries with a synchronization session of sessionₘ.

In step 1102, the client iterates over the set of logged state change entries created (see FIG. 9) on the client during sessionₘ. Note that the compression performed by the client ensures that at most one state change entry exists per datum Dᵢ. Note that the client need not order the set of state change entries to facilitate processing.

In step 1104, the client determines whether any state change entries remain to be processed. If none remain, the client terminates the process in step 1106. If at least one remains, in step 1108, the client selects the state change entry and determines whether it corresponds to a create operation, a delete operation or an update operation. If the operation is a create operation, in step 1110, the client reverses the operation by deleting the datum whose identity is specified in the state change entry. If the operation is a delete operation, in step 1112, the client creates the datum, assigning to it a value corresponding to the before-image specified in the state change entry, and thus restoring the datum to its original state. If the operation is an update operation, in step 1114, the client retrieves the datum via an operation using the identity of the datum as specified in the state change entry, then assigns to the retrieved datum a value corresponding to the before-image specified in the state change entry. Iteration continues until all state change entries in sessionₘ, have been processed.

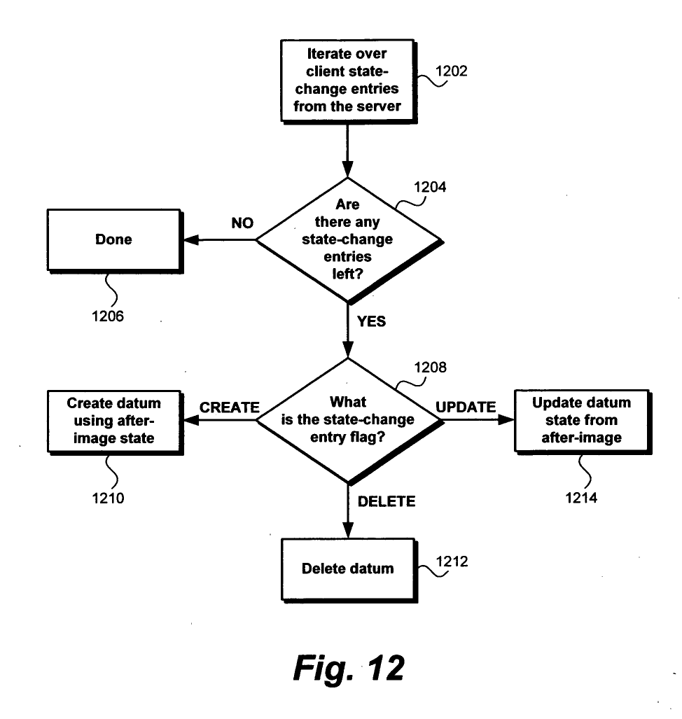

FIG. 12 shows an exemplary flowchart for system operations performed by the redo middleware through which a client performs a “redo” operation. The “redo” operation updates the client's local database to incorporate the state changes which occurred on the server during a specified sequence of transactions demarcated by transactionₛ and transactionₑ, inclusive.

In step 1202, the client iterates over the set of logged state change entries created on the server corresponding to a specified sequence of transactions demarcated by transactionₛ and transactionₑ (see FIG. 6). Note that the compression performed by the server, as described in FIGS. 5 and 6, ensures that at most one state change entry exists per datum Dᵢ. Note that the client need not order the set of state change entries transmitted by the server to facilitate processing.

In step 1204, the client determines whether any state change entries remain to be processed. If none remain, the client terminates the process in step 1206. If at least one entry remains, in step 1208, the client determines whether the state change entry corresponds to a create operation, a delete operation or an update operation. If the operation is a create operation, in step 1210, the client creates the datum, assigning to it a value corresponding to the after-image specified in the state change entry. If the operation is a delete operation, in step 1212, the client deletes the datum whose identity is specified in the state-change entry. If the operation is an update operation, in step 1214, the client assigns to the datum identified in the state change entry a value corresponding to the after-image specified in the state change entry. Iteration continues until all state change entries corresponding to the sequence of transactions demarcated by transactionₛ and transactionₑ have been processed.

After the processing described in FIGS. 10, 11 and 12 is complete, the client's database mirrors that of the server database as of the completion of transactionₑ on the server. It is emphasized that the client database may be a subset of the server database, in which case only those features of the server's database to which the client has subscribed will have been mirrored.

The foregoing description of the invention has been presented for purposes of illustration and description. It is not intended to be exhaustive or to limit the invention to the precise form disclosed, and other modifications and variations may be possible in light of the above teachings. For example, the present invention may be implemented as computer hardware, and can be embodied on a computer chip that accepts as input a sequence of database operations (e.g., through a parallel bus) and writes to output (e.g., another parallel bus) a compressed sequence of database operations.

Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for compressing state changes to a datum in a primary data storage system, the method comprising:
receiving a first state-change entry describing at least a first transformation of the datum and a first value of the datum;
receiving a second state-change entry describing at least a second transformation of the datum and a second value of the datum; and
reducing the first and second state-change entries to a compressed state-change entry, the compressed state-change entry including at least a compressed transformation and a compressed value, the compressed transformation and compressed value being functionally equivalent to applying the first transformation and first value, then applying the second transformation and second value, to the datum.

2. The method of claim 1, wherein each of the state-change entries includes an indication as to whether the state change represents a creation of the datum, a deletion of the datum, or an update of the datum.

3. The method of claim 1, wherein reducing the first and second state-change entries is iteratively performed over a specified range of activity.

4. The method of claim 1, further comprising bringing a current state of the datum in a secondary data storage system to the same state described by the compressed state-change entry.

5. The method of claim 4, further comprising reversing changes to the datum made at the secondary data storage system while the second data storage system was not coupled to the primary data storage system.

6. The method of claim 1, wherein reducing the first and second state-change entries to the compressed state-change entry further comprises:
replacing the first value with the second value and storing the first state-change entry as the compressed state-change entry if the first transformation corresponds to a create operation and the second transformation corresponds to an update operation;
removing the first state-change entry if the first transformation corresponds to the create operation and the second transformation corresponds to the delete operation;
converting the second transformation to an update operation and storing the second state-change entry as the compressed state-change entry if the first transformation corresponds to a delete operation and the second transformation corresponds to the create operation;
storing the second state-change entry as the compressed state-change entry if the first transformation corresponds to the update operation and the second transformation corresponds to the update operation; and
storing the second state-change entry as the compressed state-change entry if the first transformation corresponds to the update operation and the second transformation corresponds to the delete operation.

7. The method of claim 1, wherein reducing the first and second state-change entries to the compressed state-change entry further comprises:
leaving the first state-change entry unchanged if the first transformation corresponds to a create operation and the second transformation corresponds to an update operation;
removing the first state-change entry if the first transformation corresponds to the create operation and the second transformation corresponds to the delete operation;
changing the first transformation to an update operation if the first transformation corresponds to a delete operation and the second transformation corresponds to the create operation;
leaving the first state-change entry unchanged if the first transformation corresponds to the update operation and the second transformation corresponds to the update operation; and
changing the first state-change entry to a delete operation if the first transformation corresponds to the update operation and the second transformation corresponds to the delete operation.

8. A system for replicating data, the system comprising:
a primary data store, the primary data store including at least one datum;
a logging unit configured to log state changes of the datum;
a replicating unit configured to compress a plurality of state-change entries into a functionally equivalent state-change entry.

9. The system of claim 8, further comprising at least one application coupled to the data store, the application configured to change the datum from a first state to a second state.

10. The system of claim 8, wherein the logging unit is further configured to indicate whether state changes of the datum represents a creation of the datum, a deletion of the datum, or an update of the datum.

11. The system of claim 8, further comprising an undo unit configured to reverse changes to the data store since a previous replication between a client and server.

12. The system of claim 8, further comprising a redo unit configured to receive compressed state information from a server and bring a client and the server to a same updated state.

13. A computer program product embodied in a tangible media comprising:
computer readable program codes coupled to the tangible media for compressing state changes to a datum in a primary data storage system, the computer readable program codes configured to cause the program to:
receive a first state-change entry describing at least a first transformation of the datum and a first value of the datum;
receive a second state-change entry describing at least a second transformation of the datum and a second value of the datum; and
reduce the first and second state-change entries to a compressed state-change entry, the compressed state-change entry including at least a compressed transformation and a compressed value, the compressed transformation and compressed value being functionally equivalent to applying the first transformation and first value, then applying the second transformation and second value, to the datum.

14. The computer program product of claim 13, wherein each of the state-change entries includes an indication as to whether the state change represents a creation of the datum, a deletion of the datum, or an update of the datum.

15. The computer program product of claim 13, wherein the computer readable program codes configured to reduce the first and second state-change entries are iteratively performed over a specified range of activity.

16. The computer program product of claim 13, further comprising computer readable program codes configured to bring a current state of the datum in a secondary data storage system to the same state described by the compressed state-change entry.

17. The computer program product of claim 16, further comprising computer readable program codes configured to reverse changes to the datum made at the secondary data storage system while the second data storage system was not coupled to the primary data storage system.

18. The computer program product of claim 13, wherein the computer readable program codes configured to reduce the first and second state-change entries to the compressed state-change entry further comprise computer readable program codes configured to:
replace the first value with the second value and storing the first state-change entry as the compressed state-change entry if the first transformation corresponds to a create operation and the second transformation corresponds to an update operation;
remove the first state-change entry if the first transformation corresponds to the create operation and the second transformation corresponds to the delete operation;
convert the second transformation to an update operation and storing the second state-change entry as the compressed state-change entry if the first transformation corresponds to a delete operation and the second transformation corresponds to the create operation;
store the second state-change entry as the compressed state-change entry if the first transformation corresponds to the update operation and the second transformation corresponds to the update operation; and
store the second state-change entry as the compressed state-change entry if the first transformation corresponds to the update operation and the second transformation corresponds to the delete operation.

19. The computer program product of claim 13, wherein the computer readable program codes configured to reduce the first and second state-change entries to the compressed state-change entry further comprise computer readable program codes configured to:
leave the first state-change entry unchanged if the first transformation corresponds to a create operation and the second transformation corresponds to an update operation;
remove the first state-change entry if the first transformation corresponds to the create operation and the second transformation corresponds to the delete operation;
change the first transformation to an update operation if the first transformation corresponds to a delete operation and the second transformation corresponds to the create operation;
leave the first state-change entry unchanged if the first transformation corresponds to the update operation and the second transformation corresponds to the update operation; and
change the first state-change entry to a delete operation if the first transformation corresponds to the update operation and the second transformation corresponds to the delete operation.
